(19) United States
(12) Patent Application Publication
(10) Pub. No.: US 2021/0131822 A1
(43) Pub. Date: May 6, 2021

(54) EXPLORATION OF AN UNKNOWN ENVIRONMENT BY AN AUTONOMOUS MOBILE ROBOT

(71) Applicant: Robart GmbH, Linz (AT)

(72) Inventors: Harold Artes, Linz (AT); Dominik Seethaler, Linz (AT)

(73) Assignee: Robart GmbH, Linz (AT)

(21) Appl. No.: 16/645,997

(22) PCT Filed: Sep. 12, 2018
(86) PCT No.: PCT/EP2018/074607

§ 371 Date: Dec. 30, 2020

(30) Foreign Application Priority Data
Sep. 12, 2017 (DE) 10 2017 121 128.4

(51) Int. Cl. G01C 21/00; G05D 1/02; G05D 1/00; A47L 11/40

(52) U.S. Cl. CPC G01C 21/3848; G05D 1/0274; G05D 1/0225; G05D 1/0219; G05D 1/0088; G01C 21/383; G05B 13/0265; A47L 11/4061; G05D 2201/0203; G05D 2201/0207; G05D 2201/0215; A47L 2201/04; A47L 11/4011

(57) ABSTRACT

A method for exploration of a robot operating zone by an autonomous mobile robot. The method involves the starting of an exploration run, wherein the robot during the exploration run detects objects in its environment and stores detected objects as map data in a map, while the robot moves through the robot operating zone. During the exploration run, the robot carries out a partial region detection based on the stored map data, wherein at least one reference partial region is detected. The robot repeats the partial region detection in order to update the reference partial region and again checks whether the (updated) reference partial region has been fully explored. The exploration of the reference partial region is continued until the check reveals that the reference partial region has been fully explored.

### TECHNICAL FIELD

The specification relates to the field of autonomous mobile robots, especially methods for exploration of an environment as yet unknown to the autonomous mobile robot in a robot operating zone.

### BACKGROUND

Many autonomous mobile robots can be obtained for the most diverse of private or commercial applications, such as the processing or cleaning of floor surfaces, the transport of objects, or the inspection of an environment. Simple devices work without the composing and use of a map of the robot areas of applications, for example by moving randomly over a floor surface to be cleaned (see, e.g., the publication EP 2287697 A2 of iRobot Corp.). More complex robots use a map of the robot areas of applications which they compose themselves or are provided in electronic form.

Before the map can be used for a trajectory planning (and other purposes), the robot must explore its environment in the robot operating zone in order to compose a map. Methods are known for the exploration of an environment not familiar to the robot. For example, techniques such as “Simultaneous Localization and Mapping (SLAM) can be used in an exploration phase of a robot application. The inventors propose to solve the problem of improving the process of exploration of an environment not yet familiar to the robot within a robot operating zone.

### SUMMARY

The aforementioned problem can be solved with a method according to claim 1 or 16, as well as with a robot control system according to claim 19. Various exemplary embodiments and further developments are the subject matter of the dependent claims.

A method is described for exploration of a robot operating zone by an autonomous mobile robot. According to one exemplary embodiment, the method involves the starting of an exploration run, wherein the robot during the exploration run detects objects in its environment and stores detected objects as map data in a map, while the robot moves through the robot operating zone. During the exploration run, the robot carries out a partial region detection based on the stored map data, wherein at least one reference partial region is detected. It is then checked whether the reference partial region has been fully explored. The robot repeats the partial region detection in order to update the reference partial region and again checks whether the (updated) reference partial region has been fully explored. The exploration of the reference partial region is continued until the check reveals that the reference partial region has been fully explored. The robot then continues the exploration run in another partial region, if another partial region has been detected, using the other partial region as a reference partial region.

According to another exemplary embodiment, the method involves starting an exploration run in a first of many rooms of the robot operating zone, connected by door openings. The robot during the exploration run detects objects in its environment and stores the detected objects as map data in a map, while the robot moves through the robot operating zone. Furthermore, the robot detects one or more door openings during the exploration run and checks whether the first room has already been fully explored. The exploration run is continued in the first room until the check reveals that the first room is fully explored. The exploration run can then be continued in another room.

### BRIEF DESCRIPTION OF THE DRAWINGS

Various exemplary embodiments shall be explained more closely below with the aid of figures. The representations are not necessarily true to scale and the invention is not just confined to the aspects shown. Instead, emphasis is placed on representing the underlying principles. The figures show:

FIG. 1 illustrates an autonomous mobile robot in a robot operating zone.

FIG. 2 illustrates with the aid of a block diagram an example of the construction of an autonomous mobile robot.

FIG. 3 shows a map automatically created by a mobile robot of its robot operating zone (a residence) with a plurality of boundary lines.

FIG. 4 shows an example of the result of an automated partitioning of the robot operating zone into partial regions.

FIG. 5 illustrates with the aid of a flow chart an example of a method for the complete exploration of a robot operating zone.

FIG. 6 illustrates the mapping of obstacles by the robot.

FIG. 7 illustrates the movement of the robot through an operating zone to be explored.

FIGS. 8-13 illustrate the steps of the exploration of a robot operating zone with multiple rooms.

### DETAILED SPECIFICATION

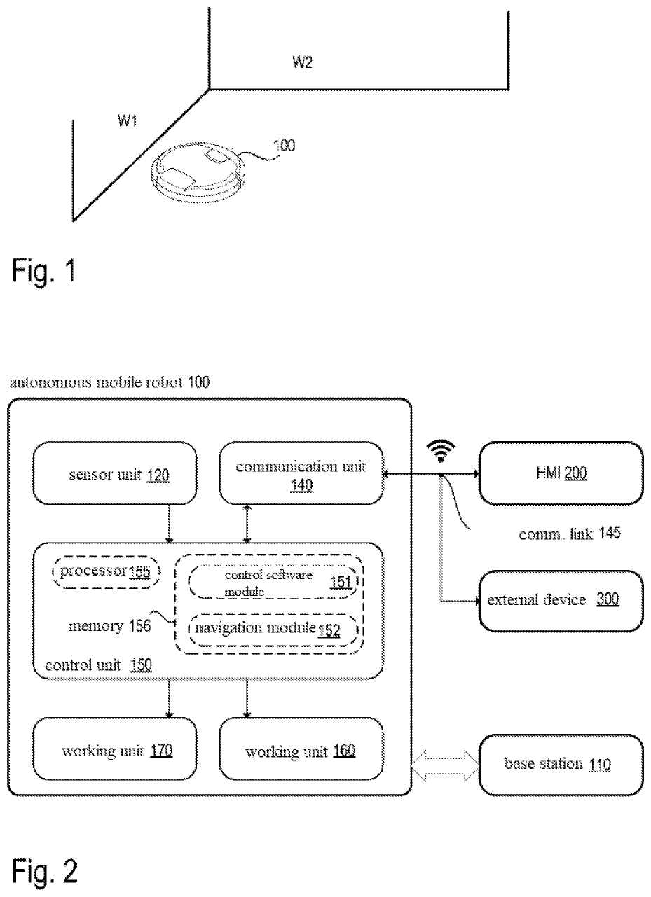

FIG. 1 illustrates as an example a cleaning robot 100, being the example for an autonomous mobile robot. Other examples of autonomous mobile robots are service robots, monitoring robots, telepresence robots, etc. Modern autonomous robots navigate on the basis of a map, i.e., they have at their disposal an electronic map of the robot operating zone. In many situations, however, the robot has no map, or no current map of the robot operating zone and it must explore and map its (unknown) environment. This process is also known as “exploration”. In this process, the robot detects obstacles while moving through the robot operating zone. In the example shown, the robot 100 has already identified parts of the walls W1 and W2 of a room. Methods for the exploration of the environment of an autonomous mobile robot are familiar in themselves. One method often used is SLAM, as mentioned.

Furthermore, the partitioning of the map composed by the robot into partial regions is familiar in itself (see, e.g., DE 10 2010 017 689 A1). The robot will partition its map with the aid of given criteria, such as door openings detected by means of sensors, floor coverings detected, etc. The purpose of the partitioning of the robot operating zone into several partial regions is to create the possibility of individual treatment of different areas (such as the rooms of a dwelling). In the case of a cleaning robot, different partial regions can be cleaned, e.g., with different frequency, different intensity, at certain times, with certain implements or cleaning agents, etc. But a definitive partitioning of the map into partial regions is not possible until the robot has (basically completely) explored its environment. Various strategies exist for the exploration of a robot operating zone. Examples of this are random travel, travel along obstacles (especially to move around the outer contour), or even complex methods which determine a closest exploration point which the robot can head for to achieve a maximum exploration savings (see, e.g., D. Lee: The Map-Building and Exploration Strategies of a Simple Sonar-Equipped Mobile Robot (Cambridge University Press, 1996)). However, there is no method which takes account of the special circumstances of residential environments with individual rooms. The rooms are generally connected by door openings and thus are clearly bounded off from each other. At the same time, a room may be very complex, at least in the view of the robot, due to the furnishings (obstacles). This means that, with the usual strategies for exploration, the robot very often travels back and forth between the rooms, which costs a lot of time and energy. The fundamental idea of the invention is to completely explore a room before the robot moves to the next room. For this, the robot during its exploration produces a partitioning of the map into partial regions, for example in order to identify a room as a meaningful partial region. The robot can explore this partial region and determine when this partial region (and thus the room) has been fully explored.

Before discussing more closely the exploration of the environment of the robot, we shall first briefly describe the construction of an autonomous mobile robot. FIG. 2 shows as an example with the aid of a block diagram various units (modules) of an autonomous mobile robot 100. A unit or a module may be an independent subassembly or part of the software for control of the robot. A unit may comprise multiple subunits. The software responsible for the behavior of the robot 100 may be executed by the control unit 150 of the robot 100. In the example shown, the control unit 150 comprises a processor 155, which is adapted to execute software instructions contained in a storage 156. Some functions of the control unit 150 may also be executed at least partly with the aid of an external computer. That is, the computing power needed by the control unit 150 can be moved at least in part to an external computer, which can be reached for example via a home network or through the Internet (cloud).

The autonomous mobile robot 100 comprises a drive unit 170, which may have for example electric motors, gears, and wheels, by which the robot 100—at least in theory—can move toward each point of an operating zone. The drive unit 170 is adapted to convert commands or signals received from the control unit 150 into a movement of the robot 100

The autonomous mobile robot 100 further comprises a communication unit 140, in order to produce a communication link 145 to a human/machine interface (HMI) 200 and/or other external devices 300. The communication link 145 is for example a direct wireless link (e.g., Bluetooth), a local wireless network link (e.g., WLAN or ZigBee) or an Internet link (e.g., to a cloud service). The human/machine interface 200 can put out user information via the autonomous mobile robot 100 for example in visual or also acoustical form (e.g., battery status, current work task, map information such as a cleaning map, etc.) and receive user commands for a work task of the autonomous mobile robot 100. Examples of a HMI 200 are tablet PC, Smartphone, Smartwatch and other wearables, computer, Smart-TV, or Head-Mounted Displays, and so forth. A HMI 200 can additionally or alternatively be integrated directly in the robot, so that the robot 100 can be operated for example by key touch, gestures, and/or voice input and output.

Examples of external devices 300 are computers and servers, to which computations and/or data can be moved, external sensors providing additional information, or other household appliances (such as other autonomous mobile robots), with which the autonomous mobile robot 100 can interact and/or exchange information.

The autonomous mobile robot 100 may have a working unit 160, such as a processing unit for processing a floor surface and in particular for the cleaning of a floor surface (e.g., brush, vacuum cleaner) or a grip arm for the fitting and transporting of objects.

In certain instances, such as a telepresence robot or a monitoring robot, a different component is used to fulfill the intended tasks and no working unit 160 is necessary. Thus, a telepresence robot may have a communication unit 140 coupled to the HMI, which may be equipped for example with a multimedia unit, having a microphone, camera and monitor screen, for example, to enable the communication among many persons at remote physical locations. A monitoring robot during inspection runs ascertains unusual events with the aid of its sensors (such as fire, light, unauthorized persons, etc.) and gives notice of this for example to a watch station. In this case, instead of the working unit 160 there is provided a monitoring unit with sensors to monitor the robot operating zone.

The autonomous mobile robot 100 comprises a sensor unit 120 with various sensors, such as one or more sensors for the detecting of information about the environment of the robot in nits operating zone, such as the position and extension of obstacles or landmarks in the operating zone. Sensors for the detection of information about the environment are, for example, sensors for measuring of distances from objects (such as walls or other obstacles, etc.) in the environment of the robot, such as an optical and/or acoustical sensor, which can measure distances by means of triangulation or run time measurement of a signal emitted (triangulation sensor, 3D camera, laser scanner, ultrasound sensors, etc.). Alternatively or additionally, a camera may be used to gather information about the environment. In particular, the position and extension of an object can also be determined by viewing an object from two or more positions.

In addition, the robot may possess sensors for detecting a (usually unintentional) contact (or collision) with an obstacle. This may be realized by accelerometers (which detect, e.g., the change in velocity of the robot upon collision), contact switches, capacitive sensors or other tactile or touch-sensitive sensors. In addition, the robot may possess floor sensors, in order to identify an edge in the floor, such as a stairway. Other customary sensors in the field of autonomous mobile robots are sensors for determining the speed of the robot and/or the distance traveled, such as odometers or inertial sensors (acceleration sensor, turn rate sensor) for determining a change in position and movement of the robot, as well as wheel contact switches to detect a contact between wheel and floor.

The autonomous mobile robot 100 may be associated with a base station 110, at which it may charge its energy storage (batteries), for example. The robot 100 can return to this base station 110 after completing its task. When the robot has no further task to perform, it can wait at the base station 110 for a new use.

The control unit 150 may be adapted to provide all functions needed by the robot to move by itself in its operating zone and perform a task. For this, the control unit 150 comprises, for example, the processor 155 and the storage module 156 in order to execute software. The control unit 150 on the basis of the information received from the sensor unit 120 and the communication unit 140 can generate control commands (e.g., control signals) for the working unit 160 and the drive unit 170. The drive unit 170, as already mentioned, can convert these control signals or control commands into a movement of the robot. The software contained in the storage 156 may have a modular design. For example, a navigation module 152 provides functions for the automatic production of a map of the robot operating zone, and for planning the movement of the robot 100. The control software module 151 provides, for example, general (global) control functions and can form an interface between the individual modules.

In order for the robot to perform a task autonomously, the control unit 150 may comprise functions for the navigation of the robot in its operating zone that are provided by the aforementioned navigation module 152. These functions are familiar in themselves and may include one of the following, among others:
the producing of (electronic) maps by gathering information about the environment with the aid of the sensor unit 120, for example but not only by means of SLAM methods,
the management of one or more maps for one or more operating zones of the robot associated with the maps,
the determining of the position and orientation (posture) of the robot in a map based on the information about the environment ascertained with the sensors of the sensor unit 120,
a map-based trajectory planning from a current posture of the robot (start point) to a target point,
a contour following mode, in which the robot (100) moves along the contour of one or more obstacles (such as a wall) at a substantially constant distance d from this contour,
a partial region identification, in which the map is analyzed and broken down into partial regions, in which spatial boundaries such as walls and door openings are identified, whereby the partial regions describe the rooms of a dwelling and/or meaningful partial regions of these rooms.

The control unit 150 can constantly update a map of the robot operating zone with the aid of the navigation module 152 and based on the information of the sensor unit 120, for example during the operation of the robot, such as when the environment of the robot changes (obstacle moved, door opened, etc.). A current map can then be used by the control unit 150 for short-term and/or long-term movement planning for the robot. The planning horizon refers to the path calculated in advance by the control unit 150 for a (target) movement of the robot before it is actually carried out. The exemplary embodiments described here involve, among others, various approaches and strategies for the movement planning in particular situations, e.g., situations in which certain maneuvers are blocked by obstacles and therefore cannot be carried out.

In general, an (electronic) map which can be used by the robot 100 is a collection of map data (such as a database) for saving of position-related information about an operating zone of the robot and the environment relevant to the robot in this operating zone. In this context, “position-related” means that the stored information is associated each time with a position or a posture in a map. A map thus represents a plurality of data records with map data, and the map data can contain any given position-related information. The position-related information can be saved in different degrees of detail and abstraction, and can be adapted to a specific function. In particular, individual information items may be saved redundantly. However, oftentimes a collection of multiple maps regarding the same region but saved in different form (data structure) is likewise called “a map”.

A technical device is most useful to a human user in everyday life if on the one hand the behavior of the device is clear and comprehensible to the user and on the other hand an intuitive operation is possible. It is generally desirable for an autonomous mobile robot (such as a floor cleaning robot) to exhibit an intuitively comprehensible and practical behavior for a human user. For this, the robot must interpret its operating zone by technical methods and divide it into partial regions in a way similar to what a human user would do (e.g., living room, bedroom, hallway, kitchen, dining area, etc.). This enables a simple communication between user and robot, for example in the form of simple commands to the robot (such as “clean the bedroom”) and/or in the form of messages to the user (such as “cleaning of bedroom finished”). Furthermore, the mentioned partial regions can be used for the displaying of a map of the robot operating zone and the operating of the robot by means of this map.

Now, a partitioning of the robot operating zone into partial regions by a user can be done on the one hand by recognized conventions and on the other hand by personal preference (and thus user-specific, such as dining area, children's play room, etc.). One example of a known convention is the subdividing of a dwelling into different rooms, such as bedroom, living room and hallway. According to one user-specific exemplary subdividing, a living room could be divided into a kitchen area, a dining area, or areas in front of and behind the sofa. The boundaries between these areas might sometimes be defined very “vague” and are generally subject to the interpretation of the user. A kitchen area, for example, might be characterized by a tile floor, while the dining area is characterized merely by the presence of a table and chairs. The adapting to the human user might be a very difficult task for a robot and often a robot/user interaction may be needed to correctly perform the partitioning of the robot operating zone. For a simple and comprehensible robot/user interaction, the map data and the partitioning already done automatically must be interpreted and processed by the device. Furthermore, the human user expects a behavior of the autonomous mobile robot adapted to the partitioning done. Therefore, it may be desirable to provide the partial regions with attributes by the user or automatically, thus influencing the behavior of the robot.

One technical requirement for this is that the autonomous mobile robot has a map of its operating zone, in order to orient itself here with the aid of the map. This map is constructed by the robot itself, for example, and it is stored permanently. In order to accomplish the goal of an intuitive partitioning of the robot operating zone for the user, technical methods are needed which (1) automatically perform a partitioning of the map of the robot operating zone, such as a dwelling, according to given rules, (2) allow a simple interaction with the user, in order to conform to the partitioning wishes of the user, not known a priori, (3) preprocess the automatically generated partitioning in order to represent it easily and understandably to the user in a map, and (4) derive by itself certain attributes from the partitioning so created that are suitable to achieving the behavior expected by the user.

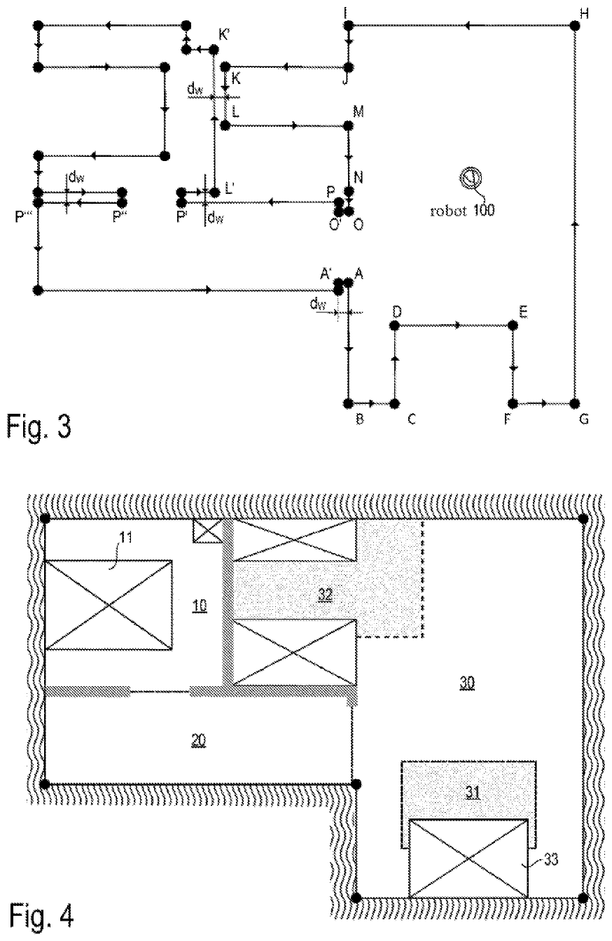

FIG. 3 shows one possible representation of a map of a robot operating zone, such as is constructed by the robot, e.g., by means of sensors and a SLAM algorithm. For example, the robot measures with the aid of a distance sensor the distance to obstacles (such as a wall, furniture, a door, etc.) and calculates line segments from the measurement data (usually a point cloud), which define the boundaries of its operating zone. The operating zone of the robot may be defined, for example, by a closed chain of line segments (usually a simple concave traverse), each line segment having a start point, an end point, and consequently also a direction. The direction of the line segment indicates which side of the line segment points into the interior of the operating zone or the side from which the robot has “seen” the obstacle, which is indicated by a particular line segment. The polygon represented in FIG. 3 completely describes the operating zone for the robot, but is only poorly suited to a robot/user communication. A human user might have difficulty in recognizing his or her own dwelling and becoming oriented in it. An alternative to the mentioned chain of line segments is a grid map, where a grid of, e.g., 10×10 cm is placed on top of the robot operating zone, and each cell (i.e., a 10×10 cm box) is marked that is occupied by an obstacle. Such grid maps are also very hard for a human user to interpret.

Not only to simplify the interaction with a human user, but also to “work off” the operating zone in a sensible manner (from the standpoint of the user), the robot should first of all divide its robot operating zone in automated manner into partial regions (i.e., perform a partial region detection). Such a subdivision into partial regions allows the robot to perform its task in its operating zone in an easier, more systematic, differentiated, and “logical” manner (from the standpoint of the user), and to improve the interaction with the user. In order to achieve a sensible subdivision, the robot must weight various sensor data against one another. In particular, it can use information on the passability (easy/difficult) of a region of its operating zone to define a partial region. Furthermore, the robot can proceed on the (disprovable) assumption that rooms are generally rectangular. The robot can learn that certain changes in the partitioning will lead to more meaningful results (so that, e.g., particular obstacles will lie with a certain probability in a particular partial region).

As is shown in FIG. 3, a robot is usually capable of recognizing obstacles by means of sensors (such as laser distance sensors, triangulation sensors, ultrasound distance sensors, collision sensors, or a combination of these) and to draw the boundaries of its operating zone in the form of boundary lines in a map. However, the limited sensors of a robot generally do not allow a clear recognition of a self-evident (to a human user) subdivision of the operating zone into different rooms (e.g., bedroom, living room, hallway, etc). Not even the decision as to whether the boundary lines contained in the map (such as the line between points J and K in FIG. 3) belong to a wall or to a piece of furniture is easily possible in automated manner Also the “boundary” between two rooms is not easily identifiable for a robot.

In order to solve the mentioned problems and to enable an automated subdividing of the robot operating zones into different partial regions (such as rooms), the robot produces “hypotheses” as to the environment of the robot based on the sensor data, which are tested by various methods. If a hypothesis can be falsified, it is rejected. If two boundary lines (such as lines A-A′ and O-O′ in FIG. 3) are approximately parallel and at a spacing which corresponds to the usual clear width of a door opening (for which there are standardized dimensions), the robot can form the hypothesis “door opening” and conclude from this that it separates two different rooms. In the most simple instance, an automatically produced hypothesis can be tested by the robot “polling” the user, i.e., requesting feedback from the user. The user can then either confirm or reject the hypothesis. However, a hypothesis can be tested in automated fashion, by checking the conclusions resulting from the hypothesis for plausibility. If the rooms identified by the robot (e.g., by means of detecting of door thresholds) encompass a central room which is smaller than one square meter, for example, the hypothesis ultimately leading to this small central room is probably false. Another automated test may involve checking whether the conclusions resulting from two hypotheses contradict each other or not. For example, if six hypotheses regarding a door can be constructed and the robot can detect a threshold (a small step) only for five supposed doors, this might be a sign that the hypothesis regarding the door without a threshold is false.

When producing a hypothesis by the robot, various sensor measurements are combined. For example, for a door opening these are the opening width, opening depth (given by the wall thickness), the existence of a wall at the right and left of the opening or a door protruding into the room. These information items may be determined by the robot with a distance sensor, for example. A door threshold over which the robot travels can be detected by an acceleration sensor or a position sensor (e.g., a gyroscopic sensor). Additional information can be ascertained by image processing and a measuring of the ceiling height.

Another example of a possible hypothesis is the course of walls in the robot operating zone. These are characterized, among other things, by two parallel lines, having a spacing of a typical wall thickness (see FIG. 3, thickness dw) and which have been seen by the robot from two opposite directions (e.g., the lines K-L and L′ -K′ in FIG. 3). However, other objects (obstacles) such as wardrobes, shelves, flower pots, etc., may be standing in front of a wall, and these also can be identified with the aid of hypotheses. A hypothesis may also be based on another hypothesis. Thus, for example, a door is an interruption in a wall. Thus, if reliable hypotheses can be made as to the course of walls in the operating zone of the robot, these can facilitate the recognizing of doors and thus the automated partitioning of the robot operating zone.

In order to test and evaluate hypotheses, they can be assigned a degree of plausibility. In one simple exemplary embodiment, a predefined point score is given to each hypothesis for each confirming sensor measurement. If a particular hypothesis has reached a minimum number of points in this way, it is regarded as being plausible. A negative number of points might result in a rejecting of the hypothesis. In another developed exemplary embodiment, a probability is assigned to a particular hypothesis coming true. This requires a probability model allowing for correlations between different sensor measurements, but also making possible complex probability statements with the aid of stochastic computation models and thus a more reliable predicting of the expectations of the user. For example, the door widths might be standardized in certain regions (e.g., countries) where the robot will be used. If the robot measures such a standardized width, it is therefore a door with high probability. Departures from the standard widths reduce the probability of it being a door. For example, a probability model based on a normal distribution can be used for this. Another possibility of producing and evaluating hypotheses is the use of “machine learning” to construct suitable models and dimensional functions (see, e.g., Trevor Hastie, Robert Tibshirani, Jerome Friedman: “The Elements of Statistical Learning”, 2nd ed. Springer-Verlag, 2008). For this, map data is recorded in different residential environments by one or more robots, for example. This may then be supplemented with floor plans or data entered by a user (e.g., regarding the course of walls or door openings or a desired partitioning) and be evaluated by a learning algorithm.

Another method which can be used alliteratively or additionally to the use of the above explained hypotheses is the dividing of a robot operating zone (such as a dwelling) into multiple rectangular regions (e.g., rooms). This approach is based on the assumption that rooms are generally rectangular or can be composed of several rectangles. In a map produced by a robot, this rectangular shape of the rooms is not generally identifiable, since numerous obstacles in the rooms with complex boundaries, such as furniture, restrict the operating zone of the robot.

Based on the assumption of rectangular rooms, the robot operating zone is tiled with rectangles of different size, which are meant to reproduce the rooms. In particular, the rectangles are chosen such that a rectangle can be distinctly coordinated with each point on the map of the robot operating zone accessible to the robot. That is, the rectangles generally do not overlap. It is not ruled out that a rectangle will contain points not accessible to the robot (e.g., because furniture prevents accessibility). Thus, the region described by the rectangles may be larger and of more simple geometrical shape than the actual robot operating zone. In order to determine the orientation and size of the individual rectangles, long straight boundary lines are used for example in the map of the robot operating zone, such as occur for example along walls (see, e.g., FIG. 3, line through points L′ and K′, line through points P and P′ as well as P″ and P′″). Different criteria are used for the choice of the boundary lines to be used. One criterion may be, e.g., that the respective boundary lines are approximately parallel or orthogonal to a plurality of other boundary lines. Another criterion may be that the respective boundary lines lie approximately on a line and/or are relatively long (i.e., on the order of the outer dimensions of the robot operating zone). Other criteria for the choice of the orientation and size of the rectangles are identified door openings or floor cover boundaries, for example. These and other criteria may be used for their evaluation in one or more evaluation functions (analogously to the degree of plausibility of a hypothesis, e.g., the assigning of a point score to a hypothesis) in order to determine the specific shape and position of the rectangles. For example, points are awarded to the boundary lines for fulfilled criteria. The boundary line with the highest point score is used as the boundary between two rectangles.

Based on the assumption that rooms are substantially rectangular, the robot can complete the outermost boundary lines from the map of boundary lines (see FIG. 3) to form a rectangular polygon (rectilinear polygon). One possible result of a dividing of a map into partial regions is shown for example in FIG. 4. Accordingly, the dwelling has been divided into different rooms (e.g., bedroom 10 with bed, hallway 20, living room with open kitchen area 30). The dividing of the dwelling into partial regions 10, 20, 30 (rooms) has been done, e.g., based on detected door openings. Then the partial regions 31 (kitchen area, tiled floor) and 32 (carpet floor) were split off from the partial region 30 (living room with open kitchen area) based on detected floor coverings (the remaining partial region 30 has, e.g., a parquet floor).

As already mentioned, a substantially complete map of the robot operating zone is generally needed before the robot can perform a meaningful automatic subdividing of a map into partial regions (such as rooms). Until then, the robot will move through the robot operating zone, unable to obey partial region boundaries. This may lead to inefficient and, to the user, hard to understand behavior of the robot in the “exploration phase”. For example, the robot passes through a door opening and arrives in another room before it has fully explored one room, which may mean that the robot has traveled through a large portion of the robot operating zone (such as a dwelling), yet still “blank spots” remain in the map in various places of the dwelling (in different rooms). The robot must then head for these “blank spots” in the map individually in order to explore them and obtain a complete map. The exemplary embodiments described here involve, among others, a method for organizing the mentioned exploration phase more efficiently at least in some situations and making the behavior of the robot seem more “logical” to the user in this exploration phase.

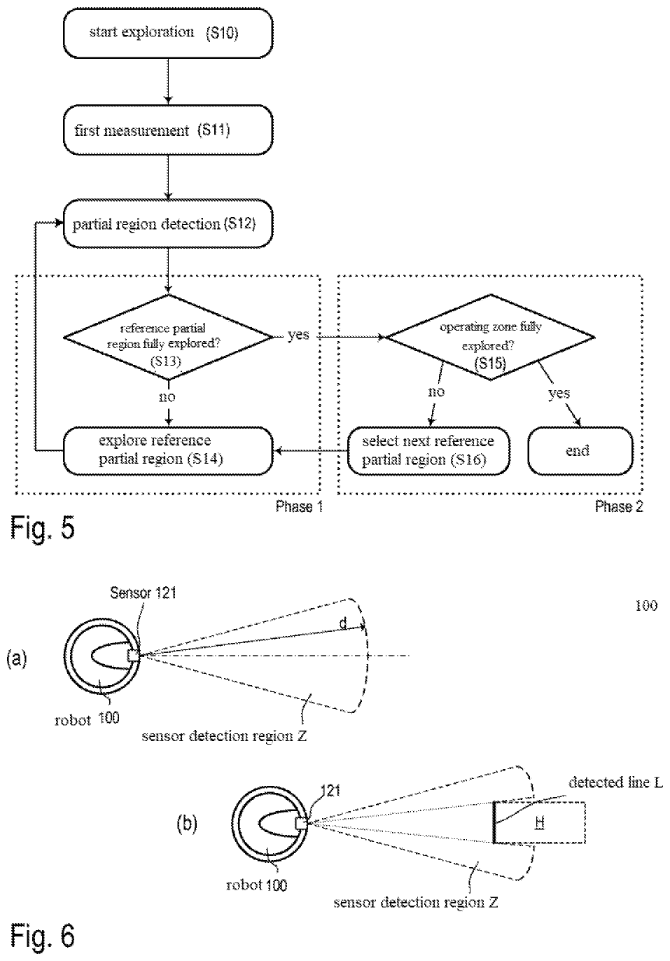

FIG. 5 illustrates an exemplary example of a method for the exploration of a robot operating zone by an autonomous mobile robot (see FIG. 1, robot 100). An exploration run can be started at any given point in the robot operating zone (FIG. 5, step S10), and during the exploration run the robot moves through the robot operating zone. The robot at the start of the exploration run has little or no information about its environment. The (electronic) map of the robot is newly created and this is practically empty at the beginning of the exploration. The robot 100 performs ongoing measurements during the exploration run (FIG. 5, step S11) in order to detect objects (such as obstacles, generally also known as navigation features) in its environment, and it stores the detected objects as map data in a map. For example, walls and other obstacles (such as furniture and other objects) are detected and their position and posture are saved in the map. The sensors used for the detection are known in themselves and can be contained in a sensor unit 120 of the robot 100 (see FIG. 2). Calculations needed for the detection can be carried out by a processor contained in the control unit 150 (see FIG. 2) of the robot 100.

During the exploration run, the robot 100 performs a partial region detection based on the current map data (see FIG. 5, step S12), wherein at least one reference partial region is detected (e.g., a portion of the robot operating zone in which the robot is presently located). Furthermore, a check is done to see whether the reference partial region has been fully explored (see FIG. 5, step S13). As long as this is not the case, the robot continues to explore (only) the reference partial region (see FIG. 5, step S14) by performing ongoing measurements to detect objects in the environment of the robot and to store detected objects in the map. The partial region detection is repeated continuously and/or by predetermined rules in order to update the determination of the reference partial region. The robot then once more checks to see whether the (updated) reference partial region has been fully explored (return to step S13). Once the check reveals that the (updated) reference partial region has been fully explored, a further check is made to see whether the robot operating zone has already been fully explored (see FIG. 5, step S15). For example, the robot may have detected during a partial region detection a further partial region, which was not yet fully explored. From this the robot can conclude that the exploration of the robot operating zone is not yet complete and continue the exploration in another partial region (FIG. 5, step S16), which then becomes the reference partial region. If the robot can no longer detect any further partial region which has not yet been explored, the exploration of the robot operating zone is finished.

For the updating of the reference partial region, the partial region detection can take account of both the current map data and the previous boundaries of the reference partial region (i.e., those found during a previous partial region detection). The ongoing updating of the reference partial region shall be explained more closely later on (see FIGS. 8 to 10). In one exemplary embodiment, the already explored portion of the robot operating zone can be broken up into one or more partial regions for the updating of the reference partial region, and the reference partial region is selected by predefined criteria from the detected partial regions. If only a single partial region is detected, this is the reference partial region. One criterion for the selection of the reference partial region may be, e.g., the extent of the overlapping with the previously established reference partial region (during the preceding partial region detection). That is, the one of the detected partial regions having the greatest overlap with the previously determined reference partial region is chosen as the current reference partial region.

Algorithms for the automated partitioning of a map into partial regions are familiar in themselves. Some of these algorithms only work when the map is fully explored, i.e., fully enclosed by walls and other obstacles. These algorithms can be used for a not fully explored map if the map is “artificially” completed. For this, for example, a frame (bounding box) can be placed around the already explored region and be regarded as a “virtual” obstacle. Other possibilities of completing an incompletely explored map in order to use the algorithms for automated partitioning of a complete map can also be used alternatively. In the exemplary embodiments described here, one or more information items based on map data may be used for the partial region detection, such as the position of walls and/or other obstacles, the position of door openings and the position of floor cover boundaries. In addition or alternatively, information about the floor structure, the ceiling structure, and/or the wall structure (stored in the map, for example) can be taken into account. A further criterion for determining a partial region are predetermined geometrical properties of partial regions, such as a minimum or a maximum size of a partial region. Ceiling structures and in particular the corners between ceiling and a wall can provide direct information as to the size and shape of a room. From this, door openings can be identified, for example, as openings in the wall not reaching up to the ceiling. Wall structures, such as windows, may furnish information as to whether that wall is an exterior wall. Floor structures, such as the change in the floor covering or a door threshold, may be indications of room boundaries and especially of door openings.

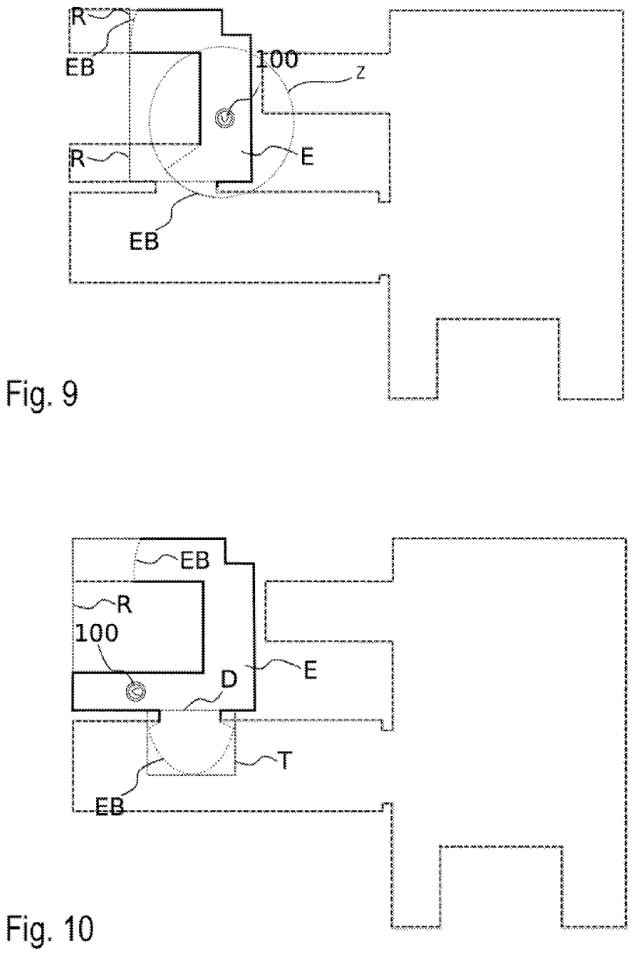

Depending on the implementation of the partial region detection, the boundary lines of a partial region can be determined at least predictively. In this context, predictively means that existing contours already detected and saved in the map (such as those of a wall) are used in order to predict a boundary line of a partial region. For example, an already detected contour of a wall already saved in the map can be prolonged (virtually) in a straight line in order to complete the boundary of a partial region. According to another example, a boundary line of a partial region parallel or at right angles to a contour of a wall (or another obstacle) already detected and saved in the map can be established such that it touches the edge of the already explored region of the robot operating zone. One example of this shall be explained later on with the aid of FIGS. 9 and 10.

The robot follows (tracking) its own position in the map. After a partial region detection, the robot can check to see whether it is still in the (updated) reference partial region. If not, and if the reference partial region is not yet fully explored, the robot returns to the reference partial region in order to continue the exploration run there. The exploration run is not continued outside of the reference partial region. But if the check reveals that the (updated) reference partial region has already been fully explored (for example, because it is bounded solely by contours of obstacles or boundary lines with other detected partial regions), a different partial region becomes the reference partial region and the exploration run is continued there.

As mentioned, the partial region detection can be repeated regularly or as a response to the detection of certain events. A repetition of the partial region detection can be triggered, e.g., when the robot determines that a particular interval of time has elapsed since the last partial region detection, that the robot has traveled a certain distance since the last partial region detection, that the explored region of the robot operating zone has grown by a particular area since the last partial region detection or that the cost for the further exploration of the reference partial region is greater than a given value. The cost may be assessed, e.g., by means of a cost function. A repetition of the partial region detection may also be triggered, e.g., if the robot has reached a target point determined for the exploration. Such a target point can be chosen, for example, on the boundary between explored and not (yet) explored partial regions. While the robot is heading for this point, it can detect new regions with its sensors and thus expand the bounds of the explored region.

When the robot determines that the reference partial region has been fully explored, this region is saved and its boundaries will no longer be changed. As long as further partial regions not fully explored exist, the robot will select another partial region as the reference partial region and continue the exploration run there. The former reference partial region (or the former reference partial regions) can be taken into account during the further partial region detection in that their boundary lines are no longer changed and thus the boundaries of neighboring partial regions are also established (at least partly). That is, the boundary lines of the former reference partial regions can be used when determining the boundary lines of further partial regions.

If the robot is a cleaning robot, it can clean a reference partial region—after it has been fully explored—before selecting another partial region as the reference region and continuing the exploration run there. This behavior can be made dependent on a user input, which heightens the flexibility of the robot. Accordingly, the robot can receive a user input, depending on which the robot distinguishes three operating modes. The user input (e.g., “explore”, “explore and clean”, “clean”) may come for example via a HMI (e.g., on a portable external device or directly on the robot). In a first operating mode, the robot performs an exploration run and the robot explores the robot operating zone, producing a new map in the process. The exploration run can be implemented according to the method described here. In a second operating mode, the robot perform an exploration run, produces a new map in this process, and also cleans the robot operating zone. In a third operating mode, no new map is produced, but the robot operating zone is cleaned based on an already existing and stored map. This concept may also be used for other robots which are not cleaning robots. In this case, the robot performs another activity instead of the cleaning

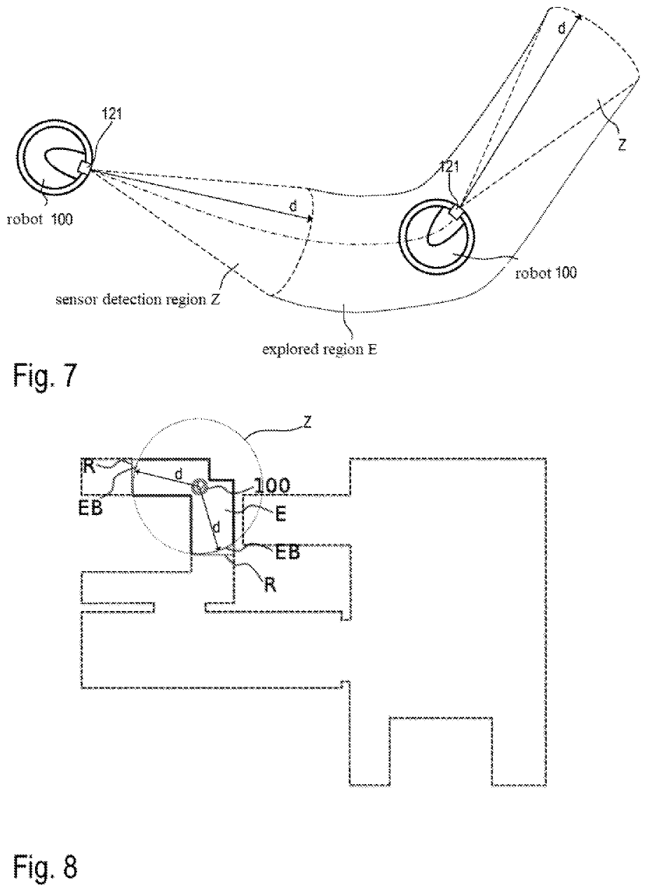

The robot can mark the already explored region of the robot operating zone as “explored” on the map (e.g., by setting a particular bit or another marking, or by detecting, updating and storing the boundaries between explored and not explored regions). For example, those regions are marked as explored on the map that are located at least once during the exploration run within a detection region of a navigation sensor of the robot (see FIG. 7). The robot can usually detect objects by means of the navigation sensor within the detection region of the navigation sensor, for example by measuring the distance between the navigation sensor and several points of an object in noncontact manner (see FIG. 6).

The robot can end the exploration run when it determines that the operating zone has been fully explored (e.g., because the region marked as explored is entirely bounded by obstacles) and/or if a continuing of the exploration run is not possible because no further partial region (not yet fully explored) has been detected. In this situation, the robot can again perform a partial region detection and consider in this process the map data regarding the completely explored robot operating zone. During this concluding partial region detection, the robot can use different (e.g., more precise and/or more expensive) algorithms than those during the repeated partial region detection of the exploration run. Alliteratively, however, the same algorithm can be used with altered parameters. Finally, after the ending of the exploration run the robot can return to a starting point at which the exploration run was started, or to a basis station that was detected during the exploration run and saved in the map.

The diagrams in FIG. 6 illustrate an example of how an autonomous mobile robot 100 explores its environment. In the example shown, the sensor unit 120 of the robot 100 (see FIG. 2) comprises a navigation sensor 121, covering a defined detection region Z (coverage area). In the example shown, the detection region Z has the approximate shape of a circle sector with radius d. This situation is represented in diagram (a) of FIG. 6. The navigation sensor 121 is adapted to detect objects (such as obstacles, furniture, and other items) in the environment of the robot 100 by measuring the distance to the contour of an object as soon as an object lies within the detection region Z of the sensor 121. The detection region Z moves along with the robot, and the detection region Z can overlap objects if the robot comes closer to them than the distance d. Diagram (b) of FIG. 6 shows a situation in which an obstacle H is located within the detection region Z of the navigation sensor 121 of the robot. The robot can identify a portion of the contour of the obstacle H, in the present example this is the line L on the side of the obstacle H facing toward the sensor 121. The line L is stored in the map. During the course of the exploration run, the robot will detect the obstacle H also from other viewing directions, and thus can complete the contour of the obstacle in the map. In the example shown, the detection region Z of the sensors has a relatively narrow field of vision. However, there are also sensors which are able to cover a range of 360°. In this case, the detection region Z has the shape of a (complete) circle. Other detection regions are also possible, depending on the sensor, and they are known in themselves. In particular, the detection region may be a volume such as an opening cone, especially in the case of sensors for three-dimensional detection of the environment.

The robot 100 generally knows its own position in the map; the robot 100 can measure changes in its position for example by means of odometry (e.g., by means of wheel sensors, visual odometry, etc). Hence, the robot also “knows” which regions of the robot operating zone it has already explored and can mark these explored regions as “explored” on the map. In the example shown in FIG. 7, the explored region E encompasses all points of the robot operating zone that were located during the exploration run at least once in the detection region Z (moving along with the robot 100). The regions of the map not marked as explored can be regarded as “blank spots”, about which the robot has no information (as of yet). It should further be noted at this point that an object H located in the detection region Z is shadowing a portion of the detection region and making it effectively smaller (see diagram (b) in FIG. 6).

FIGS. 8 to 10 illustrate the progressive exploration of a robot operating zone with multiple rooms. FIG. 8 shows a situation shortly after the beginning of an exploration run. The robot operating zone shown corresponds to that from FIGS. 3 and 4. In the present example, the exploration run starts in the upper region of the bedroom in the figure (see FIG. 4, room 10). For sake of simplicity, it is assumed that the detection region Z of the navigation sensor 121 covers 360° and is therefore circular in shape. The circle denoted as Z characterizes the theoretical maximum detection region of the sensor 121. Accordingly, the boundary EB of the explored region E is given by the identified obstacles around the robot and two circular arcs.

The robot 100 can now perform a partial region detection in order to establish a first reference partial region R (or its boundaries). The reference partial region R is bounded for example by the identified obstacles, on the one hand. On the other hand, two preliminary virtual boundary lines are defined. Since there is no further information for their position, they are established for example as straight lines lying orthogonally to the identified obstacles, touching the boundary EB of the explored region E (see FIG. 8, horizontal and vertical broken lines tangent to the circular arcs EB).

In order to further explore the reference partial region, the robot may for example try to move toward one of the boundary lines of the explored region EB not formed by a detected obstacle (such as a wall, bed, dresser, etc.). In the present example, the robot travels downward into the region of the room 10 situated at the bottom of the map while it continues to take ongoing measurements and detects obstacles in its environment and saves them in its map. This situation is represented in FIG. 9. As can be seen in FIG. 9, the explored region E has increased as compared to FIG. 8, while one corner of the wall at left of the robot partly shadows the visual field of the sensor 121 of the robot 100. In the situation shown, a portion of a door opening (to the hallway 20) already lies in the explored region E. During a repeat partial region detection, other boundaries are found for the reference partial region R. Further, predefined assumptions may go into the partial region detection, for example the assumption that a room has a substantially rectangular floor plan. According to FIG. 9, the boundary lines are chosen such that the reference partial region is a substantially rectangular surface, containing the greater portion of the explored region. The lower boundary line of the reference partial region R (horizontal broken line in FIG. 9) is generated, for example, by prolonging the contour of the wall. The left boundary line of the reference partial region R (vertical broken line in FIG. 9) is established at right angles to this, for example, so that no boundary line of the explored region EB intersects this (but only touches it in the upper region).

Thanks to the determination of the reference partial region R, the robot 100 now does not move through the door opening into the adjacent room, since it would thereby leave the reference partial region. Instead, the robot 100 remains in the reference partial region R and explores the not yet explored region (blank spot) at bottom left (in the map) and the explored region E increases further and now encompasses nearly the entire room (see FIG. 2, bedroom 10). This situation is represented in FIG. 10. During the repeated partial region detection, the robot 100 identifies the door opening to the adjacent room (see FIG. 4, hallway 20), which is entered as line D on the map and used to establish a boundary line between two partial regions. Therefore, the robot will associate the already explored region on the other side of the line D with another (new, not yet explored) partial region T. In the situation shown in FIG. 10, the partial region detection thus furnishes two partial regions, the reference partial region R and the further partial region T.

Based on the situation shown in FIG. 10, the robot will not move directly into the next partial region T (even though it is very close to the robot 100) in order to continue the exploration there, but rather it first explores the “blank spot” (upper left in the map) still present in the reference region R. After this, the robot will establish that the reference partial region R has been fully explored, since it is bounded solely by obstacles (such as walls, furniture, etc.) or a boundary line between two partial regions (line D, door opening). Only then does the robot move into the further partial region T, which is defined as a new reference partial region, and continues its exploration run there.

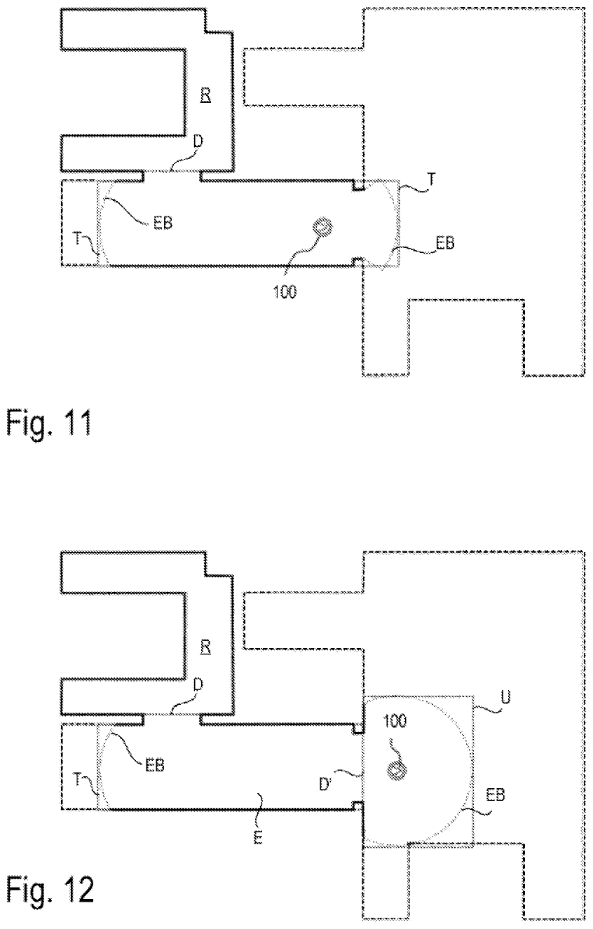

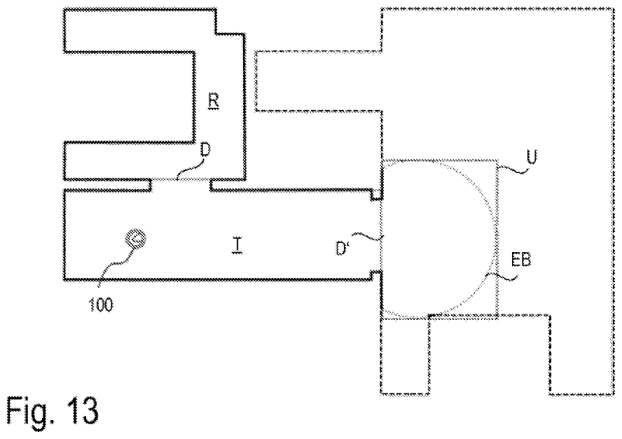

FIG. 11 shows the robot 100 during the exploration of the partial region T, which is now the reference partial region. After the robot 100 has moved through the door opening, it is deflected to the left in the example shown and follows the hallway (see FIG. 4, hallway 20) in the direction of the living room (see FIG. 4, living room 30). In FIG. 11, once again the boundaries EB of the explored region E are shown, as well as the (updated) boundaries of the reference partial region T established during the partial region detection. The boundary lines on the right and left side of the reference partial region T are straight lines, running at right angles to a detected wall and tangent to the boundaries EB of the explored region. In the representation of FIG. 11, the explored region E already extends into the adjacent room (see FIG. 4, living room 30), while the robot 100 has not yet identified the door opening to the living room as such. Therefore, the robot 100 continues the exploration run into the adjacent room and comes to a situation which is represented in FIG. 11.

In the example shown in FIG. 11, the robot 100 identifies the door opening D′ only after it has moved through it. A following partial region detection results (due to the now recognized door opening D′) in the detection of another partial region U. In this situation, the robot can recognize that it is no longer in the reference partial region T, even though it has not yet been completely explored (at left the reference partial region is not yet bounded by a detected obstacle or another already identified partial region and therefore it is incompletely explored). The robot 100 will thus return to the reference partial region T and explore it further.

In the situation represented in FIG. 13, the robot 100 has also explored the left region of the reference partial region T, and the robot will detect that the reference partial region T has now been completely explored, since it is bounded solely by detected contours of obstacles (walls) and detected adjacent partial regions R and U. Based on the situation represented in FIG. 13, the robot will now select the partial region U as a new reference partial region (because this is not yet completely explored) and continue the exploration run there.

In a simple variant of the method described here, the partial region detection is reduced to a detection of the door openings. The detection of an (open) door opening implies the detection of an adjacent room. That is, the partial region detection detects during the exploration run practically only various rooms as different partial regions. Otherwise, this exemplary embodiment is identical or similar to the previously described exemplary embodiments. The robot will first completely explore a room before it moves through a door opening to continue the exploration run in an adjacent room. If the robot should randomly travel into an adjacent room, for example because a door opening is only recognized as such after the robot has detected this door opening as such, the robot can determine that it has left the previously explored room, even though it is not yet fully explored. In this situation, the robot will end the exploration run in the room where it presently finds itself and again move through the door opening previously randomly entered (in the opposite direction) so as to return to the previously explored room and explore it further.

The methods described here can be implemented in the form of software. The software can be executed on a robot, on a human-machine interface (HMI) and/or on any other computer such as a home server or a cloud server. In particular, individual parts of the method can be implemented by means of software, which can be subdivided into different software modules and can be run on different devices. When the robot “does something” (e.g., executes a step of the method), this process (e.g., a step of the method) can be initiated by the control unit 150 (see FIG. 2). This control unit 150 (possibly together with other units) may form a controller for the autonomous mobile robot controlling all the functions and behaviors of the autonomous and mobile robot (including with the aid of other units and modules present in the robot).

1. A method for exploration of a robot operating zone by an autonomous mobile robot, comprising:
starting an exploration run, wherein the robot during the exploration run performs the following:
detecting of objects in the environment of the robot and storing detected objects as map data in a map, while the robot moves through the robot operating zone;
performing a partial region detection based on the stored map data, wherein at least one reference partial region is detected;
checking whether the reference partial region has been fully explored;
repeating the partial region detection in order to update the reference partial region and repeating the checking to see whether the updated reference partial region has been fully explored, and continuing the exploration of the updated reference partial region until the check reveals that the updated reference partial region has been fully explored; and then
continuing the exploration run in another partial region, if another partial region has been detected, using the other partial region as a reference partial region.

2. The method according to claim 1, wherein to update the reference partial region the partial region detection includes both the current map data and the previous boundaries of the reference partial region.

3. The method according to claim 2, wherein to update the reference partial region, the portion of the robot operating zone that has already been explored is broken up into one or more partial regions, wherein, from the detected partial regions, the reference partial region is chosen by predefined criteria.

4. The method according to claim 3, wherein that one of the detected partial regions is chosen as the reference partial region that has the largest overlap with the previously determined reference partial region.

5. The method according to claim 1, wherein for the partial region detection at least one of the following items of information based on the map data is used: position of walls and/or other obstacles, position of door openings, floor cover boundaries, floor structure, ceiling structure, wall structure, predetermined geometrical properties of a partial region or a combination thereof.

6. The method according to claim 1, wherein during the partial region detection, boundary lines of a partial region are at least partly ascertained predictively, by prolonging already recognized objects and using already recognized objects as boundary lines and/or by lines ascertained by predetermined criteria as boundary lines, which are in contact with that portion of the robot operating zone that has already been explored.

7. The method according to claim 1, wherein the robot checks, after a partial region detection, to see whether the robot is still located in the reference partial region, and if not, the robot returns to this region.

8. The method according to claim 1, wherein the partial region detection is repeated if the robot discovers at least one of the following events:
a given time interval since the last partial region detection has elapsed,
the robot has covered a certain distance since the last partial region detection;
the explored region of the robot operating zone has grown by a given area since the last partial region detection;
the cost for the further exploration of the reference partial region is greater than a given value, the cost being appraised with a cost function;
the robot has reached a target point set for the exploration; or
a combination thereof.

9. The method according to claim 1, wherein a reference partial region is stored and no longer changed after the robot has determined that the reference partial region is fully explored.

10. The method according to claim 9, wherein, if the exploration is continued into another partial region as the reference partial region, the previous reference partial region(s) are included in the further partial region detection so that their boundary lines are no longer changed and/or their boundary lines are included for the determination of boundary lines of further partial regions.

11. The method according to claim 1, wherein the robot is a cleaning robot, and the robot cleans a reference partial region after having determined that the reference partial region is fully explored and before continuing the exploration in a further partial region as the reference partial region.

12. The method according to claim 1, wherein the robot marks on the map those regions of the robot partial region as explored that are situated at least once during the exploration run within a detection zone of a navigation sensor of the robot.

13. The method according to claim 12, wherein the robot detects objects by of the navigation sensor within the detection zone of the navigation sensor by measuring in noncontact manner the distance between the navigation sensor and several points of an object.

14. The method according to claim 1, further comprising:
ending of the exploration run if a continuation of the exploration run is not possible because no further partial region has been detected; and
again performing a partial region detection based on the map data regarding the fully explored robot operating zone.

15. The method according to claim 1, further comprising:
ending of the exploration run if a continuation of the exploration run is not possible because no further partial region has been detected; and
returning to a starting point from which the robot started or heading for a base station that was detected during the exploration run.

16. A method for exploration of a robot operating zone by an autonomous mobile robot, comprising:
starting an exploration run in a first of many rooms of the robot operating zone, connected by door openings, wherein the robot, during the exploration run, performs the following:
detecting of objects in the environment of the robot and storing detected objects as map data in a map, while the robot moves through the robot operating zone;
detecting of one or more door openings;
checking whether the first room has already been fully explored, and
continuing the exploration run in the first room until the check reveals that the first room is fully explored; and then
continuing the exploration run in another room.

17. The method according to claim 16, wherein a door opening can be detected before, during, or after it has been passed through, and
wherein, if the robot has detected a door opening before the first room was fully explored, the robot passes through the door opening in the opposite direction in order to return to the first room.

18. The method according to claim 1, further comprising:
receiving user input by the autonomous mobile robot,
determining an operating mode according to the user input, wherein the robot is located in a robot operating zone; and
in a first operating mode, the robot operating zone is explored and a new map is produced,
in a second operating mode, the robot operating zone is explored, producing a new map and performing an activity,
in a third operating mode, an activity is performed in the robot operating zone, making use of a previously compiled and stored map for the navigation in the robot operating zone.

19. A robot controller for an autonomous mobile robot, comprising the following:
a storage for the storing of software instructions;
a processor, which is adapted to execute the software instructions, wherein, when the software instructions are executed, the processor causes the robot controller to carry out operations comprising:
starting an exploration run, wherein the robot during the exploration run performs the following:
detecting of objects in the environment of the robot and storing detected objects as map data in a map, while the robot moves through the robot operating zone;
performing a partial region detection based on the stored map data, wherein at least one reference partial region is detected;
checking whether the reference partial region has been fully explored;
repeating the partial region detection in order to update the reference partial region and repeating the checking to see whether the updated reference partial region has been fully explored, and continuing the exploration of the updated reference partial region until the check reveals that the updated reference partial region has been fully explored; and then
continuing the exploration run in another partial region, if another partial region has been detected, using the other partial region as a reference partial region.
